(19) United States
(12) Patent Application Publication
(10) Pub. No.: US 2022/0091244 A1
(43) Pub. Date: Mar. 24, 2022

(54) SYSTEMS, APPARATUSES, AND METHODS FOR ACOUSTIC MOTION TRACKING

(71) Applicant: University of Washington, Seattle, WA (US)

(72) Inventors: Anran Wang, Seattle, WA (US); Shyamnath Gollakota, Seattle, WA (US)

(73) Assignee: University of Washington, Seattle, WA (US)

(21) Appl. No.: 17/413,917

(22) PCT Filed: Jan. 17, 2020
(86) PCT No.: PCT/US2020/014077

§ 371 Date: Jun. 14, 2021

Related U.S. Application Data
(60) Provisional application No. 62/794,143, filed on Jan. 18, 2019.

(51) Int. Cl. G01S 11/14; H04R 1/40; G01S 5/30; G01S 1/74

(52) U.S. Cl. CPC G01S 11/14; G01S 1/753; G01S 5/30; H04R 1/406

(57) ABSTRACT

Systems and methods for facilitating acoustic-based localization and motion tracking in the presence of multipath, wherein, in operation, acoustic signals are transmitted from a speaker to a microphone array, a processor coupled to the microphone array calculates the 1 D distance between a microphone and/or each microphones of the microphone array and the speaker of a user device by first filtering out multipath signals with large time-of-arrival values relative to the time-of-arrival value of the direct path signal, then extracting out the phase value of the residual multipath signals and direct path signal, using the calculated 1 D distances, the processor may then calculate the intersection of the 1 D distances to determine the 3D location of the speaker to enable sub-millimeter accuracy of 1 D distance between a microphone of a microphone array and a speaker of a user device to enable smaller separation between the microphones of the microphone array.

### CROSS-REFERENCE TO RELATED APPLICATION

This application claims the benefit under 35 U.S.C. § 119 of the earlier filing date of U.S. Provisional Application Ser. No. 62/794,143 filed Jan. 18, 2019, the entire contents of which are hereby incorporated by reference in their entirety for any purpose.

### TECHNICAL FIELD

Examples described herein generally relate to motion tracking. Examples of acoustic-based motion tracking and localization in the presence of multipath are described.

### BACKGROUND

Augmented reality (AR) and virtual reality (VR) have been around for some time. While early consumer adoption of such immersive technologies was slow due to concerns over quality of user experience, available content offerings, and cost-prohibitive specialized hardware, recent years have seen a substantial increase in use of AR/VR technologies. For example, AR/VR technology is currently utilized in a number of industries, such as gaming and entertainment, e-commerce and retail, education and training, advertising and marketing, and healthcare.

Traditional AR/VR systems use either a head-mounted display (HMD) and controllers, or multi-projected environments to generate realistic images, sounds, and other sensations to simulate a user's physical presence in a virtual environment. Since virtual reality is about emulating and altering reality in a virtual space, it is advantageous for AR/VR technologies to be able to replicate how objects (e.g., a user's head, a user's hands, etc.) move in real life in order to accurately represent such change in position and/or orientation inside the AR/VR headset.

Positional tracking (e.g., device localization and motion tracking) detects the movement, position, and orientation of AR/VR hardware, such as the HMD and controllers, as well as other objects and body parts in an attempt to create the best immersive environment possible. In other words, positional tracking enables novel human-computer interaction including gesture and skeletal tracking. Implementing accurate device localization and motion tracking, as well as concurrent device localization and motion tracking, has been a long-standing challenge due at least in part to resource limitations and cost-prohibitive hardware requirements. Such challenges in device localization and motion tracking negatively impact user experience and stall further consumer adoption of AR/VR technologies.

### SUMMARY

Embodiments described herein relate to methods and systems for acoustic-based motion tracking in the presence of multipath. In operation, acoustic signals are transmitted from a speaker to a microphone array that includes a plurality of microphones. In some embodiments, the acoustic signals are FMCW signals. Additionally and/or alternatively, other acoustic signals that have multiple frequencies over time may also be used. The received signal transmitted by the speaker and received at the microphone array may include both a direct path signal as well as multipath signals.

A processor coupled to the microphone array may calculate a 1D distance between a microphone of the microphone array and the speaker of a user device. In operation, the processor first filters out multipath signals with large time-of-arrival values relative to the time-of-arrival value of the direct path signal. The processor then extracts the phase value of the residual multipath signals and direct path signal. Based on the phase value, the processor may calculate the 1D distance between the speaker and each microphone of the microphone array. The processor may further calculate the 1D distance between the remaining microphones of the microphone array and the speaker.

Using the calculated 1D distances between each microphone of the microphone array and the speaker, the processor may calculate the intersection of the 1D distances to determine the 3D location of the speaker. Advantageously, systems and methods described herein enable sub-millimeter accuracy of 1D distance between a microphone of a microphone array and a speaker of a user device. The high level of accuracy further enables smaller separation between the microphones of the microphone array.

In some examples, the speaker is located in a user device (e.g., AR/VR headset, controller, etc.), and the microphone array is located in a beacon. FIG. 2 is an exemplary illustration of such an example.

In some examples, the speaker is located in a beacon, while the microphone array is located in a user device (e.g., AR/VR headset, controller, etc.). FIG. 3 is an exemplary illustration of such an example.

In some examples, concurrent tracking of multiple user devices may occur, where there are more than one speaker, with each speaker located in a respective user device (e.g., AR/VR headset, controller, etc.), and with a single microphone array located in a beacon. FIG. 4 is an exemplary illustration of such an example.

### BRIEF DESCRIPTION OF THE DRAWINGS

Reference is now made to the following descriptions taken in conjunction with the accompanying drawings, in which:

FIG. 1 is a schematic illustration of a system for motion tracking, arranged in accordance with examples described herein;

FIG. 2 illustrates a first motion tracking system in accordance with examples described herein;

FIG. 3 illustrates a second motion tracking system in accordance with examples described herein;

FIG. 4 illustrates a third motion tracking system in accordance with examples described herein;

FIG. 5 is a flowchart of a method for calculating a distance between a speaker and a microphone of a microphone array, arranged in accordance with examples described herein; and

FIG. 6 is a flowchart of a method for calculating a distance between a speaker and a microphone of a microphone array, arranged in accordance with examples described herein.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

AR/VR technology generally facilitates human-computer interaction, including gesture and skeletal tracking by way of device localization and/or motion tracking. With the increased prevalence of use of AR/VR immersive technologies in recent years, so too is there an increased need for improved device localization and/or motion tracking technologies. Various embodiments described herein are directed to systems and methods for improved acoustic-based motion tracking in the presence of multipath. Examples described herein may provide highly accurate (e.g., sub-millimeter) one dimensional (1D) distance calculations between a speaker of a user device and a microphone array. A three dimensional (3D) tracking of the user device may then be calculated based on the 1D calculations.

Currently available motion tracking systems may suffer from a number of drawbacks. For example, specialized optical-based tracking and localization technology such as lasers and infrared beacons have been used to localize VR headsets and controllers. Such optical tracking systems, however, require specialized, and often cost-prohibitive hardware, such as separate beacons to emit infrared signals and transceivers to receive and process the data. Existing devices such as smartphones lack the transceivers required to utilize optical tracking and localization, thus such devices are unsuitable for optical tracking and localization.

Magnetic-based tracking and localization methods (also known as electromagnetic-based tracking) have also been used to determine the position and orientation of AR/VR hardware. Such solution generally relies on measuring the intensity of inhomogeneous magnetic fields with electromagnetic sensors. A base station (e.g., transmitter, field generator, etc.) sequentially generates an electromagnetic field (e.g., static or alternating). Coils are then placed into a device (e.g., controller, headset, etc.) desired to be tracked. The current sequentially passing through the coils turns them into electromagnets, allowing their position and orientation in space to be tracked. Such magnetic-based tracking systems, however, suffer from interference when near electrically conductive materials (e.g., metal objects and devices) that impact an electromagnetic field. Further, such magnetic-based systems are incapable of being upscaled.

Acoustic-based localization and tracking methods have emerged as an alternative to optical- and magnetic-based methods. Unlike optical- and magnetic-based tracking and localization methods, acoustic-based localization and tracking methods utilize speakers and microphones used for emitting and receiving acoustic signals to determine position and orientation of AR/VR hardware and other body parts during an AR/VR experience. Such speakers and microphones are less expensive and more easily accessible than the specialized hardware required for other methods, and the speakers and microphones are also are more easily configurable. For example, commodity smartphones, smart watches, as well as other wearables and Internet of things (IoT) devices already have built-in speakers and microphones, which may make acoustic tracking attractive for such devices.

Conventional acoustic-based tracking (e.g., traditional peak estimation method) is generally achieved by computing the time-of-arrival of a transmitted signal received at a microphone from a speaker. The transmitted signal may be considered to be a sine wave, x(t)=exp(−j2πft) where f is the wave frequency. A microphone at a distance of d at the transmitter, has a time-of-arrival of t_{d}=d*c where c is the speed of sound. The received signal at this distance can now be written as, y(t)=exp(−j2πt(t−t_{d}). Dividing by x(t), we get ŷ(t)=exp(j2πft_{d}). Thus, the phase of the received signal can be used to compute the time-of-arrival, t_{d}. In practice, however, multipath, that is, the propagation phenomenon that results in signals reaching a receiving antenna by two or more paths due to causes such as atmospheric ducting, ionospheric reflection and refraction, etc., may significantly distort the received phase, limiting accuracy.

To combat multipath, acoustic-based tracking and/or localization methods may use frequency modulated continuous wave (FMCW) chirps where the frequency of the signal changes linearly with time because FMCW have generally good autocorrelation properties that may allow a receiver to differentiate between multiple paths that each have a different time-of-arrival. For example, acoustic-based methods may separate the reflections of FMCW acoustic transmissions arriving at different times by mapping time differences to frequency shifts.

Mathematically, the FMCW signal can be written as:

$$x ( t ) = exp ( - j 2 π ( {f}_{0} + \frac{B}{2 T} t ) t ) = exp ( - j 2 π ( {f}_{0} t + \frac{B}{2 T} {t}^{2} ) ) \qquad Equation ( 1 )$$

where f₀, B and T are the initial frequency, bandwidth and duration of the FMCW chirp, respectively.

In the presence of multipath, the received signal can be written as:

$$y ( t ) = {\sum }_{i = 1}^{M} {A}_{i} exp ( - j 2 π ( {f}_{0} ( t - {t}_{i} ) + \frac{B}{2 T} ( {t}^{2} + {t}_{i}^{2} - 2 {tt}_{i} ) ) ) \qquad Equation ( 2 )$$

where

$${A}_{i} and {t}_{i} = \frac{{d}_{i} ( t )}{c}$$

are the attenuation and time-of-flight of the i-th path at time t.
Dividing this by x(t), Equation (2) may become:

$$\dot{y} ( t ) = {\sum }_{i = 1}^{M} {A}_{i} exp ( - j 2 π ( \frac{B}{T} {t}_{i} t + {f}_{0} {t}_{i} - \frac{B}{2 T} {t}_{i}^{2} ) ) \qquad Equation ( 3 )$$

Equation (3) illustrates that multipath with different times-of-arrival fall into different frequencies. A receiver uses a discrete Fourier transformation (DFT) to find the first peak frequency bin, fₚₑₐₖ, which corresponds to the line-of-sight path to the transmitter. The DFT then computes the distance to the receiver as

$$d ( t ) = \frac{{cf}_{peak}}{B} .$$

While acoustic-based FMCW processing may be effective in disambiguating multiple paths that are separated by large distances, it too may suffer from multiple shortcomings. For example, and as noted above, acoustic signals suffer from multipath, where the signal reflects off nearby surfaces before arriving at a receiver, and has limited accuracy when the multiple paths are close to each other. This may be especially true when considering the limited inaudible band-width on smartphones, which may limit the ability to differentiate between close-by paths using frequency shifts, thereby limiting accuracy. Further, since FFT operations are performed over a whole chirp duration, it may limit the frame rate of the system to

$$\frac{1}{T} ,$$

where T is the FMCW chirp duration.

Even further, 3D tracking of AR/VR technologies typically uses triangulation from multiple microphones and/or speakers, which when placed close to each other limits accuracy. Acoustic-based tracking systems may use multiple speakers separated by large distances (e.g., 90 centimeters), making them difficult to integrate into AR/VR headsets. Using a 90 centimeter beacon for a headset may be unworkable and limits portability.

Moreover, tracking multiple headsets remains a challenge with existing acoustic-based tracking systems as they time multiplex the acoustic signals from each device. This, however, reduces the frame rate in a linear ratio with the number of devices.

Accordingly, embodiments described herein are generally directed towards methods and systems for acoustic-based localization and/or motion tracking in the presence of multipath. In this regard, embodiments described herein enable acoustic-based localization and motion tracking using the phase of a FMCW to calculate distance between a speaker and a microphone array. Examples of techniques described herein may provide sub-millimeter resolution (e.g., substantially increased accuracy) in estimating distance (e.g., 1D distance) between the speaker and the microphone array. Based at least in part on the calculated distance, 3D tracking may be provided for the AR/VR hardware (e.g., headsets, controllers, IoT devices, etc.).

In embodiments, a speaker of a user device (e.g., AR/VR headset, etc.) may transmit an acoustic signal having multiple frequencies over time. In some embodiments, the acoustic signal is an FMCW signal. A microphone array including a plurality of microphones may receive a received signal based on the acoustic signal transmitted by the speaker. In some cases, the received signal may include a direct path signal and multiple multipath signals. In other cases, the received signal may include only a direct path signal. The processor of a computing device coupled (e.g., communicatively coupled) to the microphone array may calculate the 3D location of the speaker, including at least an orientation and/or position of the speaker, based at least in part on the received signals.

In operation, and to calculate a distance (e.g., a 1D distance) between the speaker and a microphone of the microphone array, the processor may filter the received signals (e.g., direct path signal and a plurality of multipath signals) to remove a subset of the multipath signals (e.g., distant multipath signals from the direct path). In some embodiments, an adaptive band-pass filter is used to remove the subset of multipath signals. Such filtering eliminates multipath signals with much larger times-of-arrival than the direct path signal (e.g., having a time-of-arrival greater than a threshold larger than the direct path signal). Once filtered, the residual multipath signals with similar times-of-arrival to the direct path signal (e.g. having a time-of-arrive within the threshold from the direct path signal), as well as the direct path signal, remain.

Examples of processors described herein may calculate the distance between the speaker and a microphone of the microphone array using the phase value of the direct path by approximating the effect of residual multipath signals post-filtering. In particular, recalling Equation (3), the FMCW phase of the direct path can be approximated as:

$$ϕ ( t ) \approx - 2 π ( \frac{B}{T} {tt}_{d} + {f}_{0} {t}_{d} - \frac{B}{2 T} {t}_{d}^{2} ) \qquad Equation ( 4 )$$

where t_{d} is the time-of-arrival of the direct path. In embodiments, this approximation may assume filtering has already occurred to remove the subset of multipath signals that have a much larger time-of-arrival than the direct path. Due to the filtering, the residual multipath signals and other noise can be approximated to be 0. Using Equation (4), an instantaneous estimate of t_{d} given the instantaneous phase ϕ(t) can be calculated:

$${t}_{d} ( t , ϕ ( t ) ) \approx \frac{- 2 π ( \frac{B}{T} t + {f}_{0} ) + \sqrt{4 {{π}^{2} ( \frac{B}{T} t + {f}_{0} )}^{2} + 4 π \frac{B}{T} ϕ ( t )}}{- 2 π \frac{B}{T}} \qquad Equation ( 5 )$$

The processor may then calculate the 1D distance d(t, ϕ(t)) between the speaker and the microphone of the microphone array using the phase value of the FMCW as ct_{d}(t, φ(t)), where c is the speed of light. The processor may also calculate the 1D distance between the speaker and other respective microphones of the microphone array in a similar manner.

Based on calculating the 1D distances between the microphones of the microphone array and the speaker, the processor may calculate the 3D location (e.g., orientation, position, etc.) of the speaker. In some examples, the processor may calculate the intersection of the 1D distances to triangulate the location of the speaker. In some examples, the accuracy of the 3D location triangulation may be related to the distance between the speaker and the microphone array, as well as the separation between each of the microphones of the microphone array. For example, as the distance between the microphone array and the speaker increases, the resulting 3D location tracking may become less accurate. Similarly, as the separation between microphones of the microphone array increase, the 3D location tracking accuracy may improve. This is just one reason why acoustic-based device tracking and localization techniques often utilize large-distance microphone separation (e.g., at least 90 centimeters). Once the 3D location is determined, the processor can send the information (e.g. via Wi-Fi, Bluetooth, etc.) to the speaker for further use.

Advantageously, calculating (e.g., extracting) the 1D distance between a speaker and a microphone of a microphone array using the phase value of an FMCW signal may have 10-times better accuracy (e.g., sub-millimeter accuracy) over other (e.g., frequency peak) acoustic-based FMCW tracking methods in the presence of multipath. Further, due to the high level of accuracy of the 1D distances using the phase value of the FCMW, examples described herein may provide a decrease in microphone distance separation (e.g., the microphone array may be less than 20 centimeters squared) while maintaining highly accurate 3D location tracking.

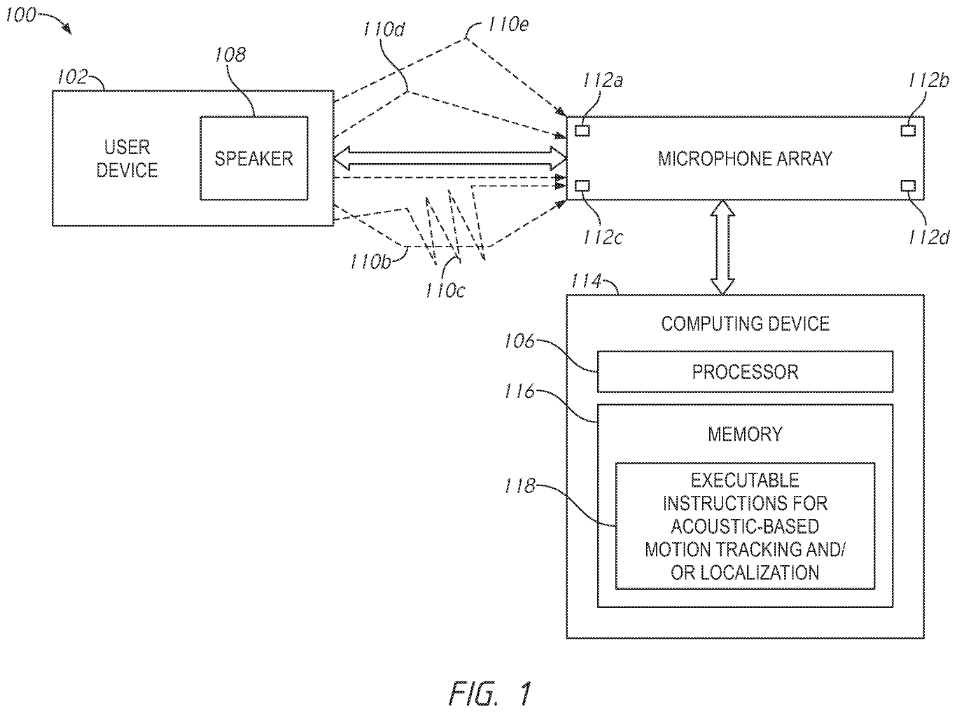

FIG. 1 is a schematic illustration of a system 100 for 3D device localization and motion tracking, arranged in accordance with examples described herein. System 100 of FIG. 1 includes user device 102, speaker 108, signals 110a-110e, microphone array 104, microphones 112a-112d, and computing device 114. Computing device 114 includes processor 106, and memory 116. Memory 116 includes executable instructions for acoustic-based motion tracking and localization 118. The components shown in FIG. 1 are exemplary. Additional, fewer, and/or different components may be used in other examples.

User device 102 may generally implement AR/VR functionality, including, for example, rendering a game instance of a game, rendering educational training, and/or the like. Speaker 108 may be used to transmit acoustic signals (e.g., signals 110a-110e) to a beacon during use of user device 102. Microphone array 104, and microphones 112a-112d, may receive the acoustic signals transmitted by speaker 108 of user device 102. Computing device 114, including processor 106, memory 116, and executable instructions for acoustic-based motion tracking and/or localization 118 may be used to track the 3D location (e.g., position and/or orientation) of speaker 108.

Examples of user devices described herein, such as user device 102 may be used to execute AR/VR functionality, including, for example, rendering a game instance of a game, rendering educational training, and/or the like in an AR/VR space. User device 102 may generally be implemented using any number of computing devices, including, but not limited to, an HMD or other form of AR/VR headset, a controller, a tablet, a mobile phone, wireless PDA, touchless-enabled device, other wireless communication device, or any other AR/VR hardware device. Generally, the user device 102 may be include software (e.g., one or more computer readable media encoded with executable instructions) and a processor that may execute the software to provide AR/VR functionality.

Examples of user devices described herein may include one or more speakers, such as speaker 108 of FIG. 1. Speaker 108 may be used to transmit acoustic signals. In some embodiments, speaker 108 may transmit acoustic signals to a microphone array, such as microphone array 104. In some examples, the speaker 108 may transmit signals that have multiple frequencies over time. Accordingly, signals transmitted by the speaker 108 may have a frequency which varies over time. The frequency variation may be linear, exponential, or other variations may be used. The frequency variation may be implemented in a pattern which may repeat over time. In some examples, the speaker 108 may transmit FMCW signals (e.g., one or more FMCW chirps). An FMCW chirp may refer to a signal having a linearly varying frequency over time—the frequency may vary between two chirp frequencies and the frequency may vary between a starting frequency and an ending frequency. On reaching the ending frequency, the chirp may repeat, varying again from the starting frequency to ending frequency (or vice versa). Generally, the signals may be provided at acoustic frequencies. In some examples, frequencies at or around a high end of human hearing (e.g., 20 kHz) may be used. In some examples, FMCW chirps may be provided having a frequency varying from 17.5-23.5 kHz.

Examples of systems described herein may include a microphone array, such as microphone array 104 (e.g., a beacon). The microphone array 104 may include microphones 112a-112d. While four microphones are shown in FIG. 1, generally any number of microphones may be included in a microphone array described herein. Moreover, the microphones 112a-112d are depicted in FIG. 1 arranged on corners of a rectangle, however, other arrangements of microphones may be used in other examples. The microphones 112a-112d may receive the acoustic signals (e.g., signals also described herein as received signal(s), such as such as signals 110a-110e) transmitted by speaker 108 of user device 102. Microphone array 104 may be communicatively coupled to a computing device, such as computing device 114 that is capable of tracking the 3D location (e.g., position and/or orientation) of speaker 108 in accordance with examples described herein.

The microphone array may be compact due the ability of systems described herein to calculate distance and/or location based on phase. Due to the accuracy of the measurement techniques described herein, compact microphone arrays may be used. For example, the microphone array may be implemented using microphones positioned within an area less than 20 centimeters squared. In some examples, less than 18 centimeters squared. In some examples, the microphones of the microphone array may be positioned at corners of a 15 cm×15 cm square. Other areas and configurations may also be used in other examples.

Examples described herein may include one or more computing devices, such as computing device 114 of FIG. 1. Computing device 114 may in some examples be integrated with one or more user device(s) and/or microphone arrays described herein. In some examples, the computing device 114 may be implemented using one or more computers, servers, smart phones, smart devices, or tablets. The computing device 114 may track the 3D location (e.g., position and/or orientation) of speaker 108. As described herein, computing device 114 includes processor 106 and memory 116. Memory 116 includes executable instructions for acoustic-based motion tracking and/or localization 118. In some embodiments, computing device 114 may be physically and/or electronically coupled to and/or collocated with the microphone array. In other embodiments, computing device 114 may not be physically coupled to the microphone array but collocated with the microphone array. In even further embodiments, computing device 114 may be neither physically coupled to the microphone array nor collocated with the microphone array.

Computing devices, such as computing device 114 described herein may include one or more processors, such as processor 106. Any kind and/or number of processors may be present, including one or more central processing unit(s) (CPUs), graphics processing units (GPUs), other computer processors, mobile processors, digital signal processors (DSPs), microprocessors, computer chips, and/or other processing units configured to execute machine-language instructions and process data, such as executable instructions for acoustic-based motion tracking and/or localization 118.

Computing devices, such as computing device 114, described herein may further include memory, such as memory 116. Any type or kind of memory may be present (e.g., read only memory (ROM), random access memory (RAM), solid state drive (SSD), and secure digital card (SD card)). While a single box is depicted as memory 116, any number of memory devices may be present. The memory 104 may be in communication (e.g., electrically connected) to processor 106.

Memory 116 may store executable instructions for execution by the processor 106, such as executable instructions for acoustic-based motion tracking and/or localization 118. Processor 106, being communicatively coupled to microphone array 104 and via the execution of executable instructions for acoustic-based motion tracking and/or localization 118, may accordingly determine (e.g., track) the 3D location (e.g., position and/or orientation) of speaker 108.

In operation, and to calculate a distance (e.g., a 1D distance) between speaker 108 and a microphone, such as microphone 112a of the microphone array 104, processor 106 of computing device 114 may filter received signals (e.g., multipath signals and a direct path signal), such as signals 110a-110e, to remove a subset of the multipath with a much larger time-of-arrival than the direct path signal. Once filtered, the residual multipath signals with similar times-of-arrival to the direct path signal, as well as the direct path signal, remain. Using the residual multipath signals and the direct path signal, processor 106 calculates the distance between speaker 108 and microphone 112a of microphone array 104 using the phase value of the direct path signal. In some examples, the residual multipath signals and corresponding noise may be discarded and/or set to 0. In some examples, the processor 106 may calculate a distance by calculating, based on a phase of the signal, a time-of-arrival of a direct path signal between the speaker 108 and microphone (e.g., in accordance with Equation (5)). The distance may accordingly be calculated by the processor based on the time-of-arrival of the direct path signal (e.g., by multiplying the time-of-arrival of the direct path signal by a speed of the direct path signal, such as the speed of light). As should be appreciated, processor 106 may further calculate distances of between speaker 108 and other microphones of the microphone array, such as microphones 112b-112d, of microphone array 104.

Based on calculating the respective distances between microphones 112a-112d of microphone array 104 and speaker 108, processor 106 may calculate the 3D location (e.g., orientation, position, etc.) of speaker 108. In particular, the processor 106 may calculate the intersection of the respective 1D distances to triangulate the location of speaker 108. Once the 3D location is determined, processor 106 can send the information (e.g. via Wi-Fi, Bluetooth, etc.) to the user device and/or another system for further use.

The distance and/or 3D location data generated in accordance with methods described herein may be generated multiple times to obtain distances and/or locations of devices described herein over time—e.g., to provide tracking. Distance and/or location data generated as described herein may be used for any of a variety of applications. For example, augmented reality images may be displayed and/or adjusted by user devices described herein in accordance with the distance and/or location data.

In the example of FIG. 1, the user device 102 is shown as including and/or coupled to the speaker 108 and the computing device 114 used to calculate distance and/or position is shown coupled to microphone array 104. However, in other examples, the user device 102 may additionally or instead include a microphone array, while the computing device 114 may additionally or instead be coupled to a speaker.

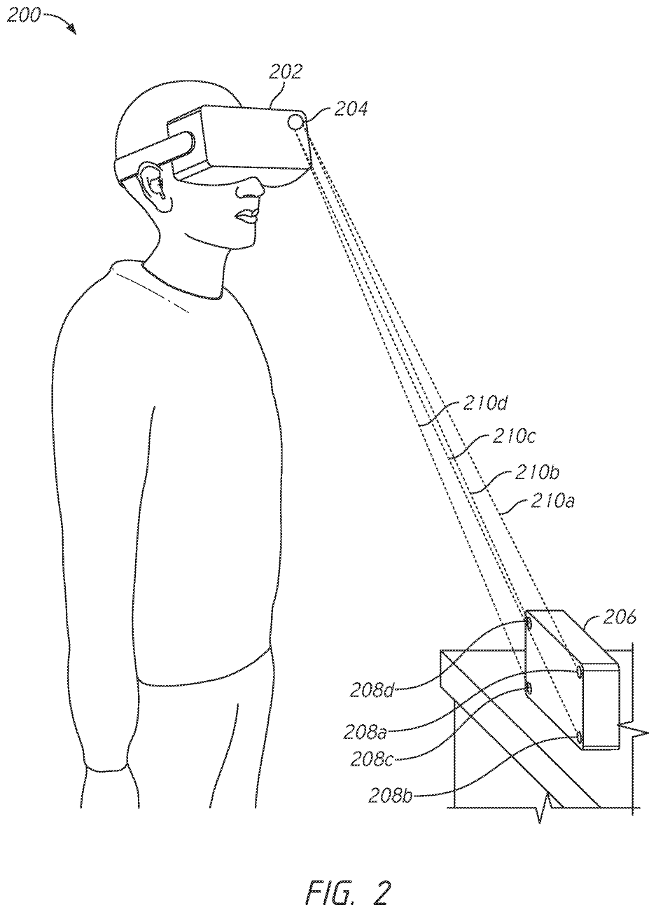

Now turning to FIG. 2, FIG. 2 illustrates a first motion tracking system in accordance with examples described herein. FIG. 2 illustrates a motion tracking scenario in which a speaker located in a user device (e.g., AR/VR headset, controller, etc.), and a microphone array is located in a beacon.

FIG. 2 includes user device 202, speaker 204, signals 210a-210d, microphone array 206 (e.g. a beacon), and microphones 208a-208d. The user device 202 may be implemented using user device 102 of FIG. 1. The speaker 204 may be implemented using speaker 108 of FIG. 1. The microphone array 206 may be implemented using the microphone array 104 of FIG. 1.

As illustrated, user device 202 is an HMD or other AR/VR headset that includes speaker 204. Speaker 204 may generally be implemented using any device that is capable of transmitting acoustic signals, such as FMCW signals. In operation, as user device 202 changes location (e.g., position and/or orientation), speaker 204 transmits acoustic signals, such as signals 210a-210d. Microphones 208a-208d of microphone array 206 (e.g., a beacon) receive signals 210a-210d transmitted from speaker 204 of user device 202. While not shown, microphone array 206 may be coupled to a processor (such as processor 106 of FIG. 1) that, using the receive signals 210a-210d, may calculate (using methods described herein) the 3D location of speaker 204 of user device 202. Once calculated, the processor may send the location information to speaker 204 of user device 202 for further use.

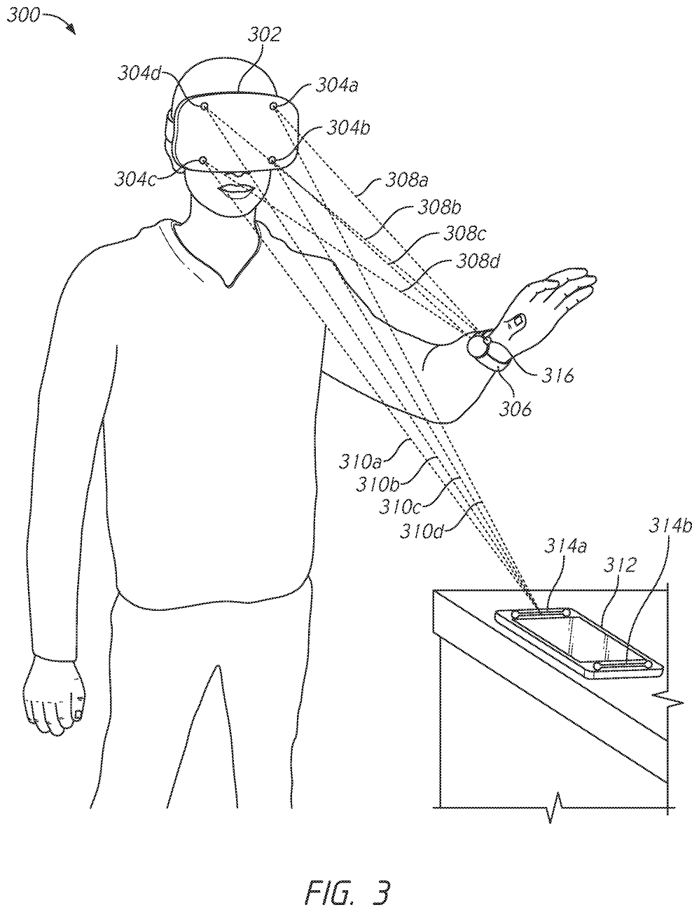

FIG. 3 illustrates a motion tracking system in accordance with examples described herein. In particular, FIG. 3 illustrates a motion tracking scenario in which a speaker is located in a beacon (e.g., mobile phone, smartwatch, etc.), while the microphone array is located in a user device (e.g., AR/VR headset, controller, etc.).

FIG. 3 includes beacon 302, microphones 304a-304d, user devices 306 and 312, speakers 314a-314b and 316, and signals 308a-308d and 310a-310d.

As illustrated, user devices 306 and 312 are a smartwatch and a mobile phone, respectively. User device 306 includes speaker 316, and user device 312 includes speakers 314a-314b. Speakers 316 and 314a-314b may each be any device that is capable of transmitting acoustic signals, such as FMCW signals. In operation, as beacon 302, including microphones 304a-304d change location (e.g., positon and/or orientation), speakers 316 and 314a-314b transmit acoustic signals, such as signals 308a-308d and 310a-310d. Microphones 304a-304d receive signals 308a-308d and 310a-310d transmitted from speakers 316 and 314a-314b of user devices 306 and 312, respectively. While not shown, beacon 302 is coupled to a computing device including a processor, memory, and executable instructions (such as computing device 114, processor 106, memory 116, and executable instructions for acoustic-based motion tracking and/or localization 118 of FIG. 1) that, using the receive signals 308a-308d and 310a-310d, may calculate (using methods described herein) the 3D location of beacon 302.

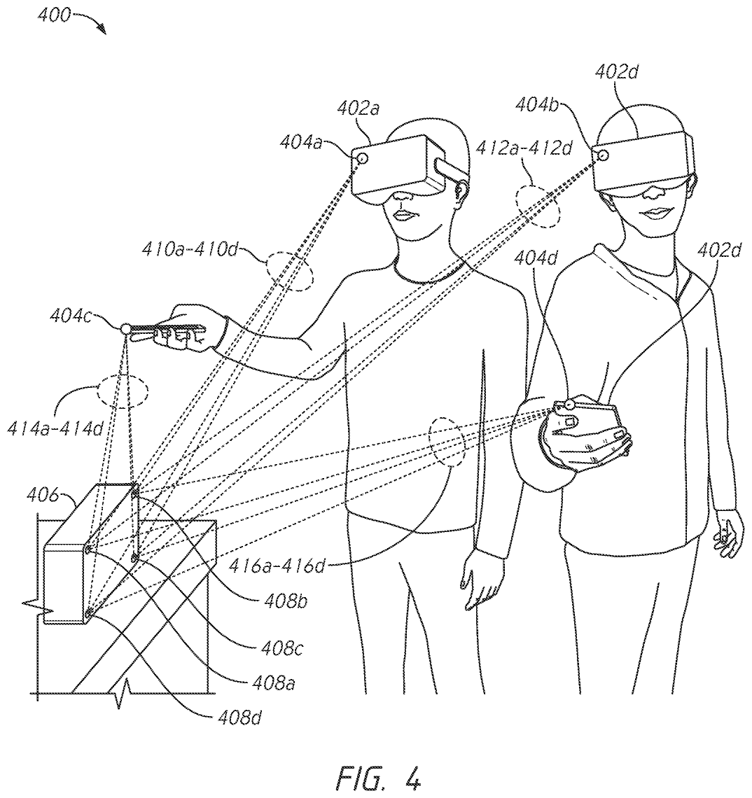

FIG. 4 illustrates a motion tracking system in accordance with examples described herein. In particular, FIG. 4 illustrates a concurrent motion tracking scenario in which there are more than one speaker (in this case more than one user), with each speaker located in a respective user device (e.g., AR/VR headset, controller, etc.), and with a single microphone array located in a beacon.

FIG. 4 includes user devices 402a-402d, speakers 404a-404d, microphone array 406 (e.g., a beacon), microphones 408a-408d, and signals 410a-410d, 412a-412d, 414a-414d, and 416a-416d.

As illustrated, user devices 402a-402d are each an HMD or other AR/VR headset, or mobile and/or handheld device that each include a speaker, such as speakers 404a-404d. Speakers 404a-404d may each be any device that is capable of transmitting acoustic signals, such as FMCW signals. In operation, as user devices 402a-402d change location (e.g., position and/or orientation), speakers 404a-404d transmit acoustic signals, such as signals 410a-410d, 412a-412d, 414a-414d, and 416a-416d. To support the concurrent transmission of signals from multiple speakers (e.g., signals 410a-410d, 412a-412d, 414a-414d, and 416a-416d from speakers 404a-404d), virtual time-of-arrival offsets are introduced for each respective user device. In operation, each respective speaker (e.g., 404a-404d) transmits FMCW signals (e.g., chirps) using time division multiplexing.

Microphones 408a-408d of microphone array 406 (e.g., a beacon) receive signals 410a-410d, 412a-412d, 414a-414d, and 416a-416d transmitted from speakers 404a-404d of user devices 402a-402d. While not shown, microphone array 406 is coupled to a computing device including a processor, memory, and executable instructions (such as computing device 114, processor 106, memory 116, and executable instructions for acoustic-based motion tracking and/or localization 118 of FIG. 1). A processor, such as processor 106 of FIG. 1 calculates the time-of-arrival for each of the received signals (e.g., denoted by t(for the i-th user device) using Equation (5). Using the calculated times-of-arrival for each signal transmitted by its corresponding user device, processor 106 calculates a virtual time-of-arrival offset for each user device. Each virtual offset for each respective user device is denoted by

$$\frac{iT}{2 N} - {t}_{d}^{i} ,$$

where N is the number of user devices (e.g., in FIG. 4, there are four user devices, 402a-402d), T is the duration of the respective FCMW signal (e.g., chirp), and t_{d}⁽ⁱ⁾ is the time-of-arrival for a respective received signal.

A processor, such as processor 106 of FIG. 1 transmits each calculated virtual time-of-arrival offsets to the corresponding speaker and user device using, e.g., a Wi-Fi connection. Each speaker then intentionally delays its transmission of acoustic signals by its corresponding virtual time-of-arrival offset (e.g., shift in time). The virtual time-of-arrival offsets ensure that the transmitted FCMW signals are equally separated across all FFT bins. Using the virtual time-of-arrival offsets may allow for concurrent speaker transmissions. As a result, when virtually offset signals from N number of user devices (e.g., 402a-402d) are received at microphones of a microphone array (e.g., microphones 408a-408d of microphone array 406), there may exist N number of separate peaks evenly distributed in the frequency domain, which corresponds to N evenly distributed times-of-arrival, where the i-th time-of-arrival is from the i-th speaker. A processor, such as processor 106 of FIG. 1 may thus regard signals from other speakers as multipath.

Using methods described here, processor 106 filters out the multipath using, e.g., a band-pass filter. Processor 106 may then track the phase of each signal using additional band-pass filters without losing accuracy or frame rate. After calculating the times-of-arrival for each signal from each respective speaker (e.g., speakers 404a-404d) processor 106 subtracts the virtual time-of-arrival offset for the corresponding speaker from the time-of-arrival for the corresponding signal to obtain the distance (e.g., 1D distance). Using methods described herein, processor 106 may further calculate distances (e.g., 1D distances) for additionally received acoustic FMCW signals. Using the calculated distances, processor 106 may calculate the 3D location of the speakers (e.g., speakers 404a-404d). Once calculated, the processor may send the location information to speakers 404a-404b of user devices 402a-402b, respectively, for further use.

Because motion, over time, the times-of-arrival for multiple speakers (e.g., speakers 404a-404d) may merge together. Such a merger may prevent a receiver (e.g., microphones 408a-408d of microphone array 406 from tracking all of the user devices concurrently. To prevent this, a processor (e.g., processor 106 of FIG. 1 transmits back a new of virtual time-of-arrival offset for each speaker of each user device (e.g., using a Wi-Fi connection) whenever the peaks between any two user devices gets close to each other in the FFT domain.

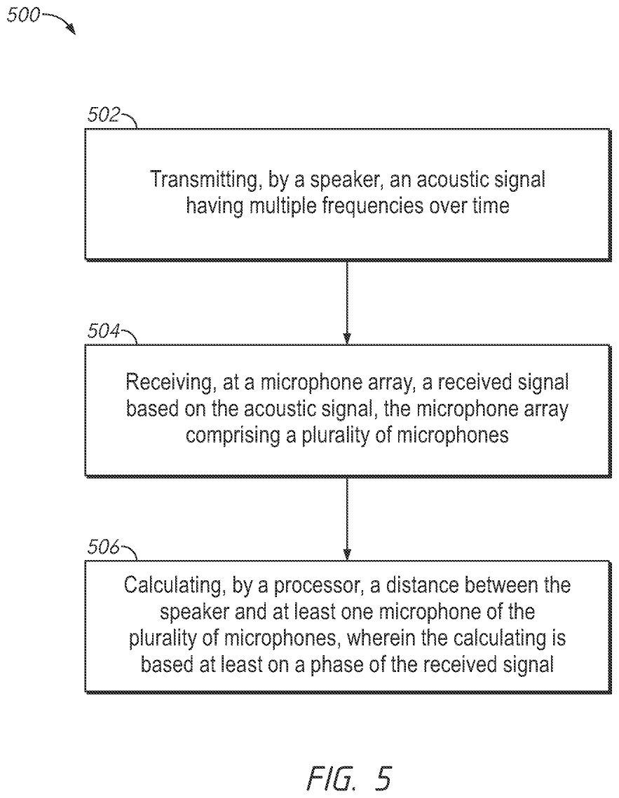

FIG. 5, FIG. 5 is a flowchart of a method arranged in accordance with examples described herein. The method 500 may be implemented, for example, using the system 100 of FIG. 1.

The method 500 includes transmitting, by a speaker, an acoustic signal having multiple frequencies over time in block 502, receiving, at a microphone array, a received signal based on the acoustic signal, the microphone array comprising a plurality of microphones in block 504, and calculating, by a processor, a distance between the speaker and at least one microphone of the plurality of microphones, wherein the calculating is based at least on a phase of the received signal in block 506.

Block 502 recites transmitting, by a speaker, an acoustic signal having multiple frequencies over time. In one embodiment, the acoustic signal transmitted may be a FCMW signal. As can be appreciated, however, other types of acoustic signals that have multiple frequencies over time may be also be used.

Block 504 recites receiving, at a microphone array, a received signal based on the acoustic signal, the microphone array comprising a plurality of microphones. In some embodiments, the received signal may include a direct path signal as well as a plurality of multipath signals. In some cases, a subset of the plurality of multipath signals may have much larger time-of-arrival values than the time-of-arrival of the direct path signal, while another subset of the plurality of multipath signals may have time-of-arrival values similar to the time-of-arrival of the direct path signal.

Block 506 recites calculating, by a processor, a distance between the speaker and at least one microphone of the plurality of microphones, wherein the calculating is based at least on a phase of the received signal. As described herein, and in operation, to calculate the distance between the speaker and at least one microphone of the microphone array, the processor filters the received signals (e.g., direct path signal and a plurality of multipath signals) to remove a subset of the multipath signals (e.g., distant multipath signals from the direct path). In some cases, an adaptive band-pass filter is used to remove the subset of multipath signals. Such filtering eliminates multipath signals with a much larger time-of-arrival than the direct path signal. Alternatively, and as can be appreciated, other filtering methods other than band-pass filtering may also be used. Once filtered, the residual multipath signals with similar times-of-arrival to the direct path signal, as well as the direct path signal, remain.

The processor calculates the 1D distance between the speaker and a microphone of the microphone array using phase. For example, the processor may calculate, using the phase of the received signal, a time-of-arrival of a direct path signal. Based on the time-of-arrival of the direct path signal, a distance may be calculated (e.g., by multiplying the time-of-arrival by a speed). For example, the Equations (4) and (5) may be used. The processor may also calculate the 1D distances for each of the remaining respective microphones of the microphone array. As described herein, the processor may use the calculated 1D distances to calculate the 3D location of the speaker.

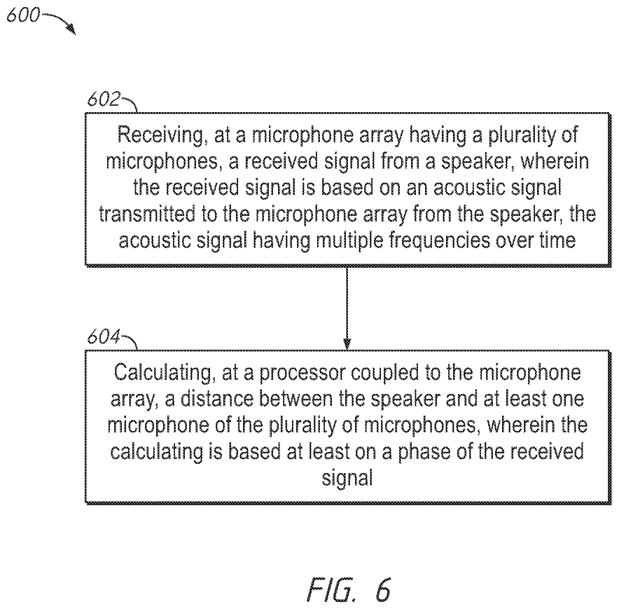

FIG. 6 is a flowchart of a method arranged in accordance with examples described herein. The method 600 may be implemented, for example, using the system 100 of FIG. 1.

The method 600 includes receiving, at a microphone array having a plurality of microphones, a received signal from a speaker, wherein the received signal is based on an acoustic signal transmitted to the microphone array from the speaker, the acoustic signal having multiple frequencies over time in block 602, and calculating, at a processor coupled to the microphone array, a distance between the speaker and at least one microphone of the plurality of microphones, wherein the calculating is based at least on a phase of the received signal in block 604.

Block 602 recites receiving, at a microphone array having a plurality of microphones, a received signal from a speaker, wherein the received signal is based on an acoustic signal transmitted to the microphone array from the speaker, the acoustic signal having multiple frequencies over time. In one embodiment, the acoustic signal transmitted may be a FCMW signal. As can be appreciated, however, other types of acoustic signals that have multiple frequencies over time may be also be used. In embodiments, the received signal may include a direct path signal as well as a plurality of multipath signals. In some cases, a subset of the plurality of multipath signals may have much larger time-of-arrival values than the time-of-arrival of the direct path signal, while another subset of the plurality of multipath signals may have time-of-arrival values similar to the time-of-arrival of the direct path signal.

Block 604 recites calculating, at a processor coupled to the microphone array, a distance between the speaker and at least one microphone of the plurality of microphones, wherein the calculating is based at least on a phase of the received signal.

As described herein, and in operation, to calculate the distance between the speaker and at least one microphone of the microphone array, the processor filters the received signals (e.g., direct path signal and a plurality of multipath signals) to remove a subset of the multipath signals (e.g., distant multipath signals from the direct path). In some cases, an adaptive band-pass filter is used to remove the subset of multipath signals. Such filtering eliminates multipath signals with a much larger time-of-arrival than the direct path signal. Additionally and/or alternatively, and as can be appreciated, other filtering methods other than band-pass filtering may also be used to filter distant multipath signals. Once filtered, the residual (e.g., remaining) multipath signals with similar times-of-arrival to the direct path signal, as well as the direct path signal, remain.

The processor calculates the 1D distance between the speaker and a microphone of the microphone array using the phase value of the direct path via Equations (4) and (5), described in detail above. The processor may also calculate the 1D distances for each of the remaining respective microphones of the microphone array. As described herein, the processor uses the calculated 1D distances to calculate the 3D location of the speaker.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

### Implemented Examples

Examples of methods described herein (e.g., MilliSonic) were implemented and tested using Android smartphones (e.g., Samsung Galaxy S6, Samsung Galaxy S9 and Samsung Galaxy S7 smartphones.). A mobile was built that emitted 45 ms 17.5-23.5 kHz FMCW acoustic chirps through the smartphone speaker. A microphone array was build using off-the-shelf electronic elements. An Arduino Due connected to four MAX9814 Electret Microphone Amplifiers was used. The elements were attached to a 20 cm×20 cm×3 cm cardboard and place the four microphone on four corners of a 15 cm 15 cm square on one side of the cardboard. A smaller 6 cm×5.35 cm×3 cm microphone array was also created. The Arduino was connected to a Raspberry Pi 3 Model B+ to process the recorded samples. The described methods are implemented in the Scala programming language so that it can run on both a Raspberry Pi and a laptop with-out modification. Multithreading was used. A test used 40 ms and 9 ms to process a single 45 ms chirp on the Raspberry Pi and PC, respectively. Hence, real-time tracking on both platforms was achieved.

The 1D and 3D tracking accuracy described herein were first tested in a controlled environment. We then recruited ten participants to evaluate the real-world performance of the methods (e.g. MilliSonic).

To get an accurate ground truth, we use a linear actuator with a PhidgetStepper Bipolar Stepper Motor Controller which has a movement resolution of 0.4 μm to precisely control the location of the platform. We place a Galaxy S6 smartphone on the platform and place our microphone array on one end of the linear actuator. At each distance location, we repeat the algorithm ten times and record the measured distances. We also implement CAT and SoundTrak. CAT combines FMCW with Doppler Effect that is estimated using an additional carrier wave and SoundTrak uses phase tracking. To achieve a fair comparison, we implement CAT using the same 6 kHz bandwidth for FMCW and an additional 16.5 kHz carrier. We implement SoundTrak using a 20 kHz carrier wave. We do not use IMU data for all three systems.

After running the test, the results (see below) for MilliSonic, CAT as well as SoundTrak show that MilliSonic achieves a median accuracy of 0.7 mm up to distances of 1 m. In comparison, the median accuracy was 4 and 4.8 for CAT and SoundTrak respectively. When the distance between the smartphone and the microphone array is between 1-2 m, the median accuracy was 1.74 mm, 6.89 mm and 5.68 mm for MilliSonic, CAT and SoundTrak respectively. This decrease in accuracy is expected since with increased distance the SNR of the acoustic signals reduces. We also note that at closer distances, the error is dominated by multipath which the systems and methods described herein may disambiguate multipath accurately.

To determine the effect of environmental motion and noise, we place the smartphone at 40 cm on the linear actuator. We invite a participant to randomly move their body at a distance of 0.2 m away from linear actuator. We also introduce acoustic noise by randomly pressing a keyboard and playing pop music using another smartphone that is around 1 m away from the linear actuator. The results (see below) illustrate that MilliSonic is resilient to random motion in the environment because of multipath resilience properties. Further, since we filter out the audible frequencies, music playing in the vicinity of our devices, does not affect its accuracy.

Tracking algorithms (such as the methods described herein) typically can have a drift in the computed distance over time. We next, measure the drift in the location as measured by our system as a function of time. We also repeat the experiment for both CAT and SoundTrak. Specifically, we place the smartphone at 40 cm on the linear actuator for 10 minutes. We place the microphone array at the end of the actuator. We measure the distance as measured by each of these techniques over a duration of 10 minutes. SoundTrak and MilliSonic uses phase to precisely obtain the clock difference of the two devices, while CAT relies on autocorrelation, which results in a larger drift (see below). We note that MilliSonic has a better stability compared to state-of-the-art acoustic tracking systems.

Unlike optical signals, acoustic signals can traverse through occlusions like cloth. To evaluate this, we place the smart-phone on a linear actuator and change its location between 0 to 1 m away from the microphone array. We place a cloth on the smartphone that occludes it from the microphone array. We then run our algorithm and compute the distance at each of the distance values. We repeat the experiments without the cloth covering the smartphone speaker. The results (see below) show that the median accuracy is 0.74 mm and 0.95 mm in the two scenarios, showing that MilliSonic can track devices through cloth. We note that this capability is beneficial in scenarios where the phone is in the pocket and the microphone array is tracking its location through the fabric.

Next, we measure the 3D localization accuracy of MilliSonic. To do this we create a working area of 0.6 m×0.6 m×0.4 m. We then print a grid of fixed points onto a 0.6 m×0.6 m wood substrate. We place the receiver on one side of the substrate, and place the smartphone's speaker at each of the points on the substrate. We also change the height of the substrate across the working area to test the accuracy along the axis perpendicular to the substrate. To compare with prior de-signs, we run the same implementation of CAT as in our experiments (e.g., 1D experiments). Note that while CAT uses a separation of 90 cm, we still use 15 cm microphone separation for CAT. This allows us to perform a head-to-head comparison as well as evaluate the feasibility of using a small microphone array

The results (see below)—which show the CDF of 3D location errors for MilliSonic and CAT in a working area across all the tested locations in our working area-show that MilliSonic achieves a median 3D accuracy of 2.6 mm while CAT has a 3D accuracy of 10.6 mm. The larger errors for CAT is expected since it is designed for microphone/speaker separations of 90 cm.

Finally, to evaluate concurrent transmissions with MilliSonic, we use five smartphones (3 Galaxy S6, 1 Galaxy S7, 1 Galaxy S9) as transmitters and one single microphone array to track all of them. We use the same experimental setup as the 1D tracking, but place all five smartphones on the linear actuator platform. We repeat experiments with different number of concurrent smartphones ranging from one to five. The results show that, when considering the 1D tracking error of each of the smartphones in the range of 0-1 m with different number of concurrent smartphones, the MilliSonic system can support multiple concurrent transmissions without affecting the accuracy.

1. A system comprising:
a speaker configured to transmit an acoustic signal having multiple frequencies over time;
a microphone array configured to receive a received signal based on the acoustic signal, the microphone array comprising a plurality of microphones; and
a processor coupled to the microphone array, the processor configured to calculate a distance between the speaker and at least one microphone of the plurality of microphones, wherein the calculating is based at least on a phase of the received signal.

2. The system of claim 1, wherein the received signal includes a direct path signal and a plurality of multipath signals.

3. The system of claim 2, wherein the calculating includes calculating time arrival for the direct path signal based on the phase of the received signal.

4. The system of claim 2, wherein the processor is further configured to filter the received signal to remove a subset of the plurality of the multipath signals.

5. The system of claim 1, wherein the processor is further configured to calculate respective distances between the speaker and each of the plurality of microphones.

6. The system of claim 5, based on calculating the respective distances, calculating a three-dimensional (3D) location of the speaker, wherein the 3D location comprises at least one of an orientation of the speaker, a position of the speaker, or combinations thereof.

7. The system of claim 1, further comprising:
a second speaker configured to transmit a second acoustic signal having multiple frequencies over time, the second acoustic signal shifted in time from the acoustic signal;
the microphone array further configured to receive a second received signal based on the second acoustic signal; and
the processor further configured to calculate a distance between the second speaker and the at least one microphone of the plurality of microphones, wherein the calculating is based at least on a phase of the second received signal.

8. The system of claim 1, wherein the acoustic signal is a frequency-modulated continuous wave (FMCW) signal.

9. The system of claim 1, wherein the speaker is located in a user device, and the microphone array is located in a beacon.

10. The system of claim 1, wherein the speaker is located in a beacon, and the microphone array is located in a user device.

11. The system of claim 1, wherein the processor calculates the distance between the speaker and the at least one microphone of the plurality of microphones with sub-millimeter accuracy, and the microphone array has an area of less than 20 centimeters squared.

12. A method comprising:
receiving, at a microphone array having a plurality of microphones, a received signal from a speaker, wherein the received signal is based on an acoustic signal transmitted to the microphone array from the speaker, the acoustic signal having multiple frequencies over time; and
calculating, at a processor coupled to the microphone array, a distance between the speaker and at least one microphone of the plurality of microphones, wherein the calculating is based at least on a phase of the received signal.

13. The method of claim 12, further comprising:
calculating, at the processor, respective distances between the speaker and each of plurality of microphones;
based on the calculating, calculating, at the processor, a three-dimensional (3D) location of the speaker, wherein the 3D location comprises at least one of an orientation of the speaker, a position of the speaker, or combinations thereof; and
transmitting, at the microphone array, the three-dimensional (3D) location of the speaker to the speaker.

14. The method of claim 12, wherein the received signal includes a direct path signal and a plurality of multipath signals.

15. The method of claim 14, wherein the calculating includes calculating time arrival for the direct path signal based on the phase of the received signal.

16. The method of claim 12, wherein the processor is further configured to filter the received signal to remove a subset of the plurality of multipath signals.

17. The method of claim 12, further comprising:
receiving, at the microphone array, a second received signal from a second speaker, wherein the second received signal is based on a second acoustic signal transmitted to the microphone array from the second speaker, the second acoustic signal having multiple frequencies over time, and wherein the second acoustic signal is shifted in time from the acoustic signal; and
calculating, at the processor, a distance between the second speaker and the at least one microphone of the plurality of microphones, wherein the calculating is based at least on a phase of the second received signal.

18. The method of claim 12, wherein the acoustic signal is a frequency-modulated continuous wave (FMCW) signal.

19. The method of claim 12, wherein the speaker is located in a user device, and the microphone array is located in a beacon.

20. The method of claim 12, wherein the speaker is located in a beacon, and the microphone array is located in a user device.
